(19) United States
(12) Patent Application Publication
(10) Pub. No.: US 2005/0286762 A1
(43) Pub. Date: Dec. 29, 2005

(54) Method and multimedia processor for processing a rotated image

(76) Inventor: Hyun-Sang Park, Cheonan-si (KR)

Correspondence Address: LAW OFFICE OF MONICA H CHOI, P O BOX 3424, DUBLIN, OH, 430160204, US

(21) Appl. No.: 11/151,054

(22) Filed: Jun. 13, 2005

(30) Foreign Application Priority Data
Jun. 29, 2004 (KR) 2004-49524

(51) Int. Cl. G06K 9/00

(52) U.S. Cl. 382/166

(57) ABSTRACT

In a multimedia co-processor, a CODEC compresses image data from a camera system, and a code buffer stores the compressed image data. The CODEC decompresses the stored image data, and a temporary storage device stores the decompressed image data. A host interface transfers the temporarily stored image data into a main memory of the camera system, and then inputs the image data from the main memory in a rotated format.

### BACKGROUND OF THE INVENTION

This application claims priority to Korean Patent Application No. 2004-49524 filed on Jun. 29, 2004 in the Korean Intellectual Property Office (KIPO), the entire contents of which are hereby incorporated by reference.

1. Field of the Invention

The present invention relates generally to image processing, and in particular to a method and multimedia processor for compressing a rotated image.

2. Description of the Related Art

Mobile systems, such as handsets for example, photograph images with the handset rotated at an angle of 90 degrees. In order to display the photographed image in a direction of a display device of the handset, the photographed image is rotated into a portrait form before being stored in the handset.

In the prior art, a frame memory is used for storing an entire original image during the process of rotating the image into the portrait form. Because recent cameras have a number of megabytes in resolution, a high capacity frame memory is required. However, such a high capacity memory increases the cost of the image processing system and consumes valuable footprint space which is undesirable for compact applications.

FIG. 1 is a block diagram of a conventional mobile system 100 such as a handset. Referring to FIG. 1, the mobile system 100 includes a camera module 110, a co-processor 120, a display driver 130, a display device 140, an RF (Radio Frequency) module 150, a main processor 160, a main memory 170, and a main bus 180.

The camera module 110 includes a sensor and an image signal processor (ISP) to generate image data when a photograph is taken. The co-processor 120 is suited for multimedia data processing and controls the display device 140. The co-processor 120 also compresses a still image according to standard formats such as the JPEG (Joint Photographic Experts Group) standard or compresses a moving picture according to standard formats such as the MPEG (Motion Picture Experts Group) standard.

The display driver 130 and the display device 140 display image data and text data. The main processor 160 is a primary processor for controlling the mobile system 100. The main processor 160 typically includes a central processing unit (CPU) such as an arm core processor and provides a platform for carrying out wireless communication via the RF module 150 and for executing various application software. The main memory 170 is a primary memory of the main processor 160. The main bus 180 is used for communication between the co-processor 120 and the main processor 160.

FIG. 2 shows a block diagram of a conventional multimedia co-processor 200 for compressing a rotated image. Referring to FIG. 2, the multimedia co-processor 200 includes a camera interface 210, a rotator 212, a frame memory 214, a horizontal/vertical scaler 220, a line buffer 222, a CODEC 224, a code buffer 226, a color converter 230, a FIFO 240 (First Input First Output), a display interface 250, and a host interface 260.

The rotator 212 and the frame memory 214 are disposed between the camera interface 210 and the horizontal/vertical scaler 220 so as to rotate image data from the camera interface 210. However, as stated above, the frame memory 214 disadvantageously results in high cost and high space occupation.

Thus, a mechanism is desired for rotating and then compressing an image without a frame memory.

### SUMMARY OF THE INVENTION

Accordingly, a multimedia co-processor of an aspect of the present invention rotates and then compresses an image without a frame memory.

In a multimedia co-processor according to an embodiment of the present invention, a CODEC compresses image data from a camera system, and a code buffer stores the compressed image data. In addition, the CODEC decompresses the stored image data, and a temporary storage device stores the decompressed image data. The multimedia co-processor also includes a host interface for transferring the temporarily stored image data into a main memory of the camera system, and for inputting the image data back from the main memory in a rotated format.

In a further embodiment of the present invention, the multimedia processor further includes a line buffer for converting the image data from the camera into block data before the CODEC compresses the block data of the image data. In that case, the line buffer converts the rotated image data read from the main memory into block data such that the CODEC compresses the block data of the rotated image data.

In another embodiment of the present invention, the host interface transfers the temporarily stored image data into the main memory in raster scan order. In addition, the host interface inputs the image data read from the main memory with horizontal and vertical coordinates being reversed for the rotated format.

In a further embodiment of the present invention, the multimedia processor further includes a horizontal/vertical scaler for performing horizontal and vertical scaling on the image data from the camera before compression of the image data.

In another embodiment of the present invention, the multimedia processor also includes a color converter for color converting the decompressed image data before storage into the temporary storage device.

In a further embodiment of the present invention, the multimedia processor further includes a switch coupled to the color converter for allowing bypass of the color converter.

In another embodiment of the present invention, the multimedia processor also includes another color converter for color converting the image data read from the main memory before compression of the image data with the rotated format. In that case, the multimedia processor may also include another switch coupled to the another color converter for allowing bypass of the another color converter.

The multimedia processor of the present invention may be used to particular advantage within a camera system having a main processor and the main memory for the main processor. In that case, the main processor reads the image data from the main memory in the rotated format for transfer to the multimedia processor.

In this manner, the multimedia processor does not include a frame memory for rotating and compressing the image data. Thus, the camera system having such a multimedia processor has low cost and low space occupation.

### BRIEF DESCRIPTION OF THE DRAWINGS

The above and other features and advantages of the present invention will become more apparent when described in detailed exemplary embodiments thereof with reference to the attached drawings in which:

FIG. 1 is a block diagram of a conventional mobile system such as a handset;

FIG. 2 is a block diagram of a conventional multimedia co-processor for compressing a rotated image;

FIG. 3 is a block diagram of a multimedia co-processor for compressing a rotated image according to an embodiment of the present invention;

FIG. 4 is a block diagram of a multimedia co-processor for compressing a rotated image according to another embodiment of the present invention;

FIG. 5 is a block diagram illustrating a multimedia co-processor for compressing a rotated image according to still another embodiment of the present invention; and

FIG. 6 is a flow chart with steps for compressing and storing a rotated image according to an embodiment of the present invention.

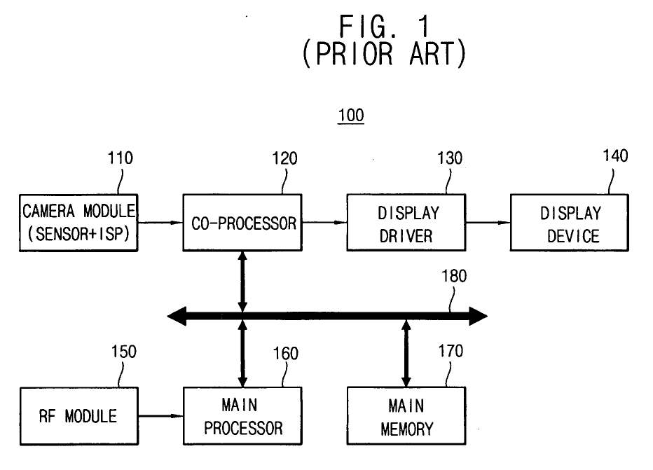

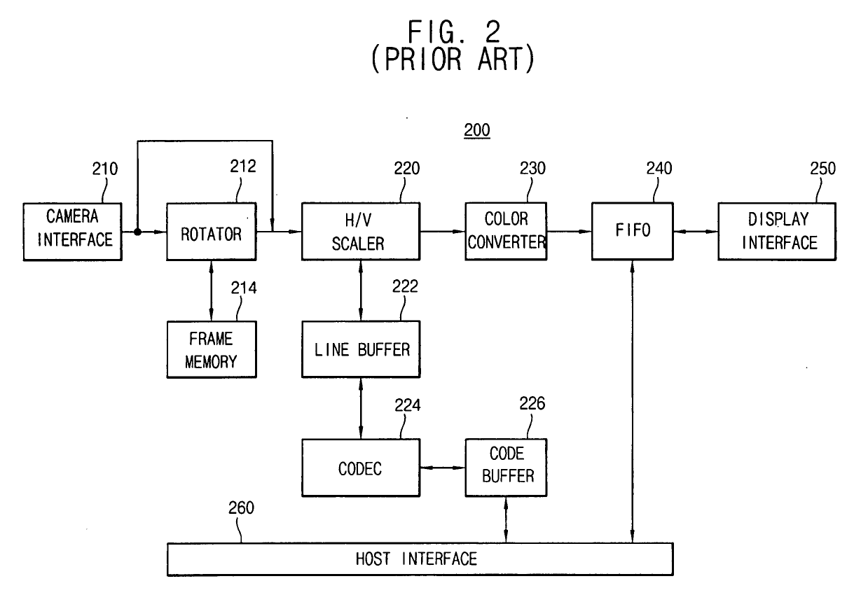

The figures referred to herein are drawn for clarity of illustration and are not necessarily drawn to scale. Elements having the same reference number in FIGS. 1, 2, 3, 4, 5, and 6 refer to elements having similar structure and/or function.

### DETAILED DESCRIPTION OF THE INVENTION

Detailed illustrative embodiments of the present invention are disclosed herein. However, specific structural and functional details disclosed herein are merely representative for purposes of describing exemplary embodiments of the present invention. This invention may be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a”, “an,” and “the” are intended to include the plural forms as well, unless the context clearly indicates otherwise. It will be further understood that the terms “comprises”, “comprising,”, “includes,” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

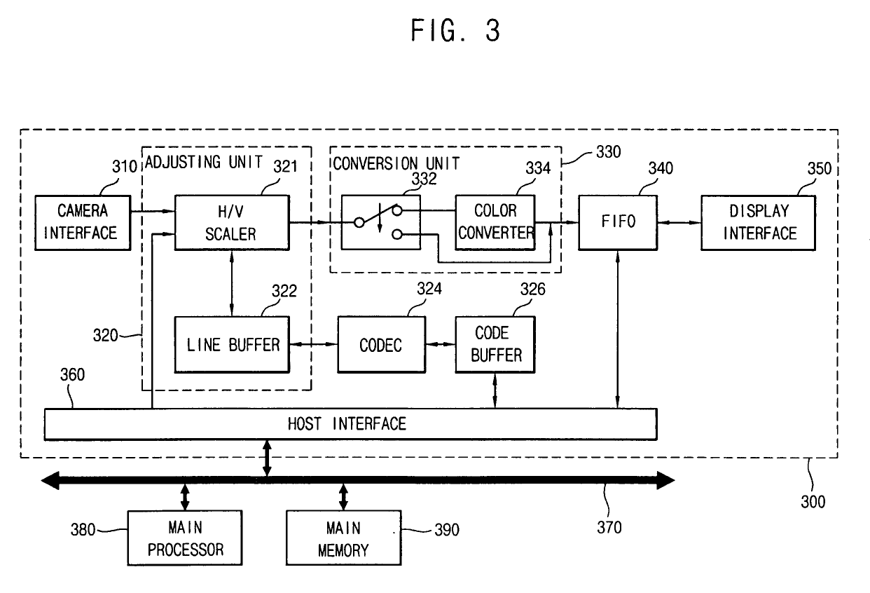

FIG. 3 is a block diagram of a multimedia co-processor 300 for compressing a rotated image according to an embodiment of the present invention. Referring to FIG. 3, the multimedia co-processor includes a camera interface 310, an adjusting unit 320, a CODEC 324, a code buffer 326, a conversion unit 330, a FIFO 340 (First Input First Output), a display interface 350, and a host interface 360.

The adjusting unit 320 includes an H/V (horizontal/vertical) scaler 321 and a line buffer 322, and the conversion unit 330 includes a switch 332 and a color converter 334. A main bus 370 is used for communication among the multimedia co-processor 300, a main processor 380, and a main memory 390. The main bus 370, the multimedia co-processor 300, the main processor 380, and the main memory 390 are parts within a camera system such as within a handset for example. The main processor 380 and the main memory 390 are used for carrying out various typical functions of the camera system.

The multimedia co-processor 300 includes blocks for displaying an image, compressing an image such as in a JPEG format, and storing an image. However, the multimedia co-processor 300 may include additional blocks for performing various additional functions.

The camera interface 310 receives image data from a camera module (not shown) in parallel or serial. The H/V scaler 321 scales an image (i.e., the image data) received from the camera module so that the scaled image has a resolution of a display device or a resolution suitable for the compression. For example, the H/V scaler 321 scales an image having a resolution of ‘640×480’ into an image having a resolution of ‘160×120’.

The color converter 334 converts a color difference format of the scaled image data into a color difference format suitable for the display device. For example, the color converter 334 converts an ‘YCbCr’ type image data into an ‘RGB’ type image data.

The FIFO 340 adjusts for a relative difference of a data processing speed between an input end and an output end of the FIFO 340. The display interface 350 is an interface circuit such as an LDI (LCD Driver IC) that transfers data in parallel or serial.

The line buffer 322 converts pixel data output from the H/V scaler 321 into block data having a given size such as 8×8 pixel blocks for compression of image data in a capture mode. The CODEC 324 compresses (or encodes) output data (or the block data) from the line buffer 322 into a JPEG file, and decompresses (or decodes) the compressed data. The host interface 360 is an interface circuit for communicating with a host system that includes the main processor 380 and the main memory 390 in parallel or serial via the main bus 370.

When the multimedia co-processor 300 is in a preview mode, an image received from an external source is simply displayed on the display device. In that case, the image received from the external source is displayed on the display device through the camera interface 310, the H/V scaler 321, the conversion unit 330, the FIFO 340, and the display interface 350. Thus in that case, the switch 332 of the conversion unit 330 is coupled to the color converter 334, and the color converter 334 outputs RGB type image data.

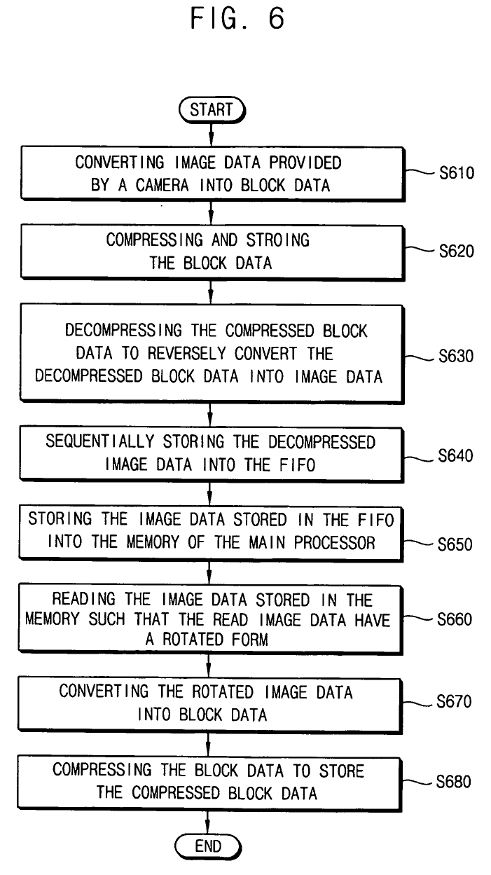

The operation for compressing and storing a rotated image in a capture mode when an image is photographed is now described with reference to FIGS. 3 and 6. First, the image data received from the external source (via the camera interface 310) passes through the H/V scaler 321 and the line buffer 322. The line buffer 322 converts the image data from the camera interface 310 into block data (step S610 of FIG. 6). The block data from the line buffer 322 is then compressed in the CODEC 324 (step S620 of FIG. 6), and the compressed block data is stored into the code buffer 326 (step S620 of FIG. 6).

Here, the H/V scaler 321 may operate selectively. For example, the H/V scaler 321 can be turned on or bypassed. That is, the captured image data may just pass through the H/V scaler 321 with the input image data not being scaled by the H/V scaler 321.

Subsequently, the compressed image data stored in the code buffer 326 is decompressed by the CODEC 324 (step S630 of FIG. 6). The decompressed image data is passed through the line buffer 322 and the H/V scaler 321 for converting the decompressed block data into image data (step S630 of FIG. 6). The decompressed image data is sequentially stored into the FIFO 340 (step S640 of FIG. 6). Again, the H/V scaler 321 may operate selectively with the H/V scaler 321 being turned on or bypassed.

During transfer of the decompressed image data into the FIFO 340, the switch 332 of the conversion unit 330 is switched over so that the switch 332 is not connected with the color converter 334. Thus, the color converter 334 may output YCbCr type image data to be stored into the FIFO 340.

In addition, the CODEC 324 may monitor the state of the FIFO 340, and when an overflow occurs in the FIFO 340, the CODEC 324 may defer an image decompressing operation. The multimedia co-processor 300 continuously performs the image decompression operation until a frame of the decompressed image data is inputted into the FIFO 340.

The main processor 380 sequentially reads the image data stored in the FIFO 340 line by line in a raster scan mode. In addition, such image data from the FIFO 340 is sequentially stored in such raster scan order into the main memory 390 (step S650 of FIG. 6).

Thereafter, the main processor 380 reads the image data stored in the main memory 390 in a rotated form (step S660 of FIG. 6). For that purpose, the main processor 380 reverses the horizontal and vertical coordinates of the image data stored in the main memory 390 for the rotated form.

The image data read from the main memory 390 passes through the H/V scaler 321 and the line buffer 322. Here, the H/V scaler 321 may operate selectively with the H/V scaler 321 being turned on or bypassed. The line buffer 322 converts pixel data output from the H/V scaler 321 into block data having a given size such as 8×8 pixel blocks (step S670 of FIG. 6). The CODEC 324 compresses the block data from the line buffer 322, and such compressed block data is stored into the code buffer 326 (step S680 of FIG. 6).

In this manner, after step 680 of FIG. 6, the image data as stored in the code buffer 326 has been rotated 900 and compressed. In addition, the multimedia co-processor 300 performs such rotation and compression without a frame memory for low cost and low space occupation.

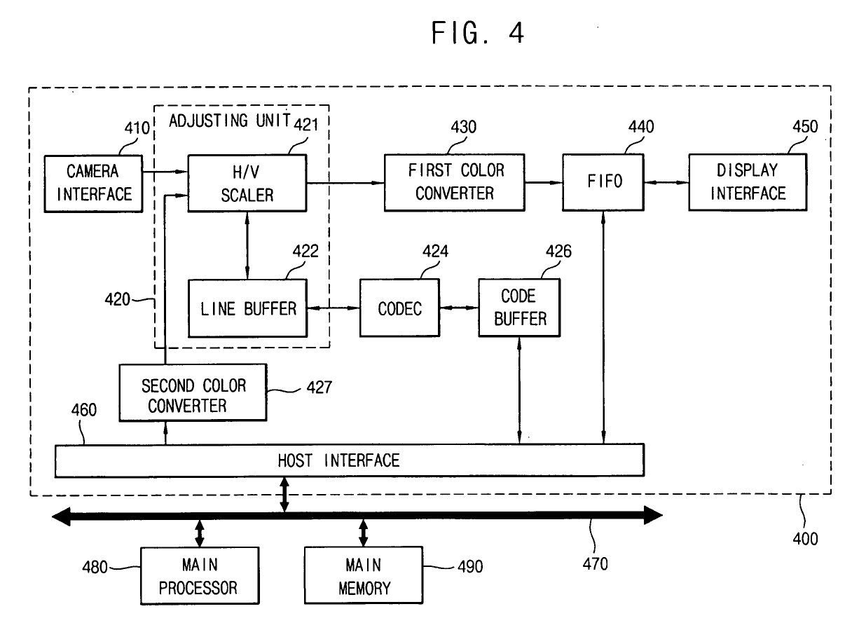

FIG. 4 shows a block diagram of a multimedia co-processor 400 for compressing a rotated image according to another embodiment of the present invention. Referring to FIG. 4, the multimedia co-processor 400 includes a camera interface 410, an adjusting unit 420, a CODEC 424, a code buffer 426, a first color converter 430, a FIFO 440, a display interface 450, a host interface 460, and a second color converter 427.

The adjusting unit 420 in FIG. 4 includes a horizontal/vertical scaler 421 and a line buffer 422. A main bus 470 is used for communication among the multimedia co-processor 400, a main processor 480, and a main memory 490.

The first color converter 430 of FIG. 4 differs from the color converter 334 of FIG. 3 in that the first color converter 430 operates regardless of a preview mode and a capture mode to output RGB type image data. In order to efficiently transfer and process image data without deteriorating an image quality within a range of a limited channel bandwidth of the FIFO 440, the image data is converted into the RGB type image data in the capture mode.

Further in FIG. 4, the additional second color converter 427 only operates in the capture mode for converting the rotated image data read from the main memory 490 back into YCbCr type image data. Such color converted image data is then provided to the adjusting unit 420.

As shown in FIG. 4, the multimedia co-processor 400 has configurations and functions identical to those of the multimedia co-processor 300 in FIG. 3 except that the multimedia co-processor 400 includes both the first color converter 430 and the additional second color converter 427. Therefore, a detailed description of the multimedia co-processor 400 of FIG. 4 is omitted.

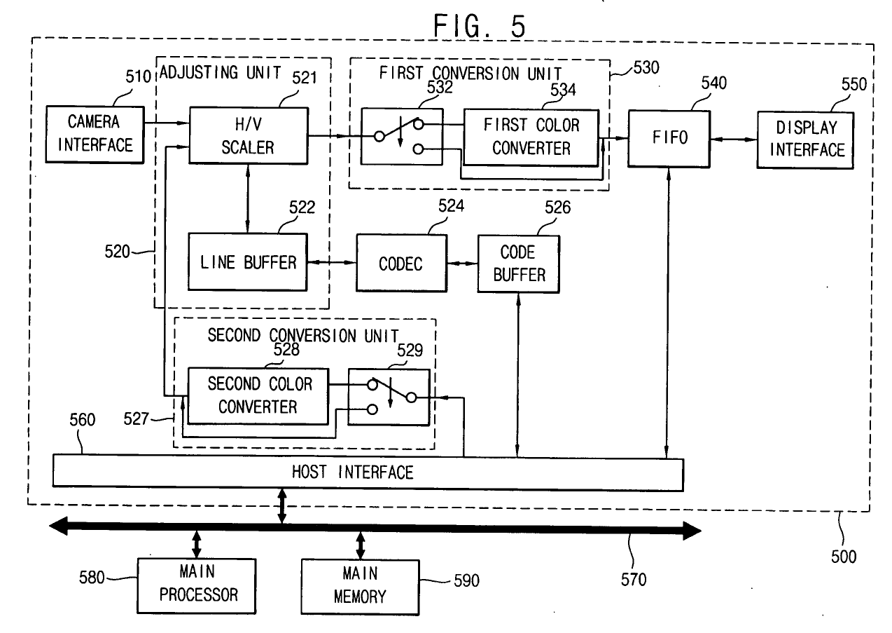

FIG. 5 shows a block diagram of a multimedia co-processor 500 for compressing a rotated image according to still another embodiment of the present invention. Referring to FIG. 5, the multimedia co-processor 500 includes a camera interface 510, an adjusting unit 520, a CODEC 524, a code buffer 526, a first conversion unit 530, a FIFO 540, a display interface 550, a host interface 560, and a second conversion unit 527.

The adjusting unit 520 includes a horizontal/vertical scaler 521 and a line buffer 522. The first conversion unit 530 includes a first switch 532 and a first color converter 534. The second conversion unit 527 includes a second switch 529 and a second color converter 528. A main bus 570 is used for communication among the multimedia co-processor 500, a main processor 580, and a main memory 590.

In an exemplary embodiment of FIG. 5, the first conversion unit 530 outputs RGB type image data in the preview mode, and may convert the image data (scaled image data) into the RGB type or YCbCr type image data in the capture mode.

Further, the second conversion unit 527 only operates in the capture mode, and may convert the rotated image data output from the main memory 590 into the RGB type or YCbCr type image data in the capture mode.

As shown in FIG. 5, the multimedia co-processor 500 has configurations and functions similar to those of the multimedia co-processor in FIGS. 3 and 4 except that the multimedia co-processor 500 includes the first conversion unit 530 and the additional second conversion unit 527. Therefore, a detailed description of the multimedia co-processor 500 of FIG. 5 is omitted herein.

Any of the multimedia co-processors according to embodiments of the present invention may be applied to any type of camera systems such as the mobile system of FIG. 1 for example. Such camera systems may be fixed or portable such as sticker photo machines, surveillance systems, and digital cameras.

In this manner, the main memory of a host system (i.e. a main processor) is used for rotating and compressing image data. Thus, a high capacity frame memory is not used for reduced cost and space occupation. While the exemplary embodiment of the present invention and their advantages have been described in detail, it should be understood that various changes, substitutions, and alterations may be made herein without departing from the scope of the invention.

1. A method of processing an image, comprising:
compressing and storing image data from a camera system;
decompressing the stored image data and storing the decompressed image data into a temporary storage device;
transferring the temporarily stored image data into a main memory of the camera system; and
reading the image data from the main memory in a rotated format.

2. The method of claim 1, further comprising:
converting the image data from the camera into block data for compressing the block data of the image data.

3. The method of claim 1, further comprising:
converting the rotated image data read from the main memory into block data; and
compressing the block data of the rotated image data and storing the compressed block data of the rotated image data.

4. The method of claim 1 wherein the temporarily stored image data is transferred into the main memory in raster scan order.

5. The method of claim 4, wherein the image data is read from the main memory with horizontal and vertical coordinates being reversed for the rotated format.

6. The method of claim 1, further comprising:
performing horizontal and vertical scaling on the image data from the camera before compressing the image data.

7. The method of claim 1, further comprising:
color converting the decompressed image data before storage into the temporary storage device.

8. The method of claim 1, wherein the temporary storage device is a FIFO (first in first out).

9. A multimedia processor comprising:
a CODEC for compressing image data from a camera system;
a code buffer for storing the compressed image data;
wherein the CODEC decompresses the stored image data;
a temporary storage device for storing the decompressed image data; and
a host interface for transferring the temporarily stored image data into a main memory of the camera system, and for inputting the image data from the main memory in a rotated format.

10. The multimedia processor of claim 9, further comprising:
a line buffer for converting the image data from the camera into block data before the CODEC compresses the block data of the image data.

11. The multimedia processor of claim 10, wherein the line buffer converts the rotated image data read from the main memory into block data, and wherein the CODEC compresses the block data of the rotated image data for storing the compressed block data of the rotated image data.

12. The multimedia processor of claim 9, wherein the host interface transfers the temporarily stored image data into the main memory in raster scan order.

13. The multimedia processor of claim 9, wherein the host interface inputs the image data read from the main memory with horizontal and vertical coordinates being reversed for the rotated format.

14. The multimedia processor of claim 9, further comprising:
a horizontal/vertical scaler for performing horizontal and vertical scaling on the image data from the camera before compression of the image data.

15. The multimedia processor of claim 9, further comprising:
a color converter for color converting the decompressed image data before storage into the temporary storage device.

16. The multimedia processor of claim 15, further comprising:
a switch coupled to the color converter for allowing bypass of the color converter.

17. The multimedia processor of claim 15, further comprising:
another color converter for color converting the image data read from the main memory before compression of the image data with the rotated format.

18. The multimedia processor of claim 17, further comprising:
another switch coupled to the another color converter for allowing bypass of the another color converter.

19. The multimedia processor of claim 9, wherein the temporary storage device is a FIFO (first in first out).

20. A camera system comprising:
a main processor;
a main memory of the main processor; and
a multimedia processor comprising:
a CODEC for compressing image data from a camera interface;
a code buffer for storing the compressed image data;
wherein the CODEC decompresses the stored image data;
a temporary storage device for storing the decompressed image data; and
a host interface for transferring the temporarily stored image data into the main memory;
wherein the main processor reads the image data from the main memory in a rotated format for transfer to the multimedia processor.

21. The camera system of claim 20, wherein the multimedia processor further includes:
a horizontal/vertical scaler for performing horizontal and vertical scaling on the image data from the camera interface before compression of the image data.

22. The camera system of claim 20, wherein the multimedia processor further includes:
a color converter for color converting the decompressed image data before storage into the temporary storage device.
